(19) United States
(12) Patent Application Publication
(10) Pub. No.: US 2020/0087202 A1
(43) Pub. Date: Mar. 19, 2020

(54) CONCRETE PRODUCT AND METHODS OF PREPARING THE SAME

(71) Applicant: S3 Concrete Technologies, Inc., Marietta, GA (US)

(72) Inventor: Jason S. Adams, Marietta, GA (US)

(73) Assignee: S3 Concrete Technologies, Inc., Marietta, GA (US)

(21) Appl. No.: 16/458,615

(22) Filed: Jul. 1, 2019

Related U.S. Application Data
(60) Provisional application No. 62/731,392, filed on Sep. 14, 2018.

(51) Int. Cl. C04B 11/30; C04B 28/02; C04B 28/14; C04B 38/00; C04B 40/00; C04B 14/06; C04B 20/00

(52) U.S. Cl. CPC C04B 11/30; C04B 28/02; C04B 28/14; C04B 2111/00008; C04B 40/0039; C04B 14/062; C04B 20/0048; C04B 38/0045

(57) ABSTRACT

A jointless concrete slab set by pouring a concrete slurry includes a) a concrete mixture; b) a colloidal silica admixture; and c) at least one reinforcing fiber selected from the group of fibers. As the poured concrete slurry cures, the poured slurry hardens into a composite material slab, and the jointless concrete slab defines capillary structures that at least in part fill with silica particles and lime, to produce a gel structure of calcium silicate hydrate. In another exemplary embodiment, the present invention is directed to a process for placing a jointless fiberless slab. The process comprises the steps of a) preparing a concrete slurry; b) pouring the concrete slurry onto the substrate; and c) allowing the concrete slurry to cure. In another exemplary embodiment, the present invention is directed to the product itself; namely, a jointless and/or fiberless concrete slab.

### RELATED APPLICATION(S)

This Application claims priority under 35 U.S.C. 119(e) to provisional patent application Ser. No. 62/731,392, filed on Sep. 14, 2018, entitled “PREPARING, PLACING, FINISHING, AND CURING A CONCRETE ADMIXTURE, AND FORMING OF CONCRETE PRODUCTS THEREFROM.” The entire contents of this provisional patent application are hereby incorporated herein by reference.

### FIELD

The present disclosure generally relates to concrete construction processes and to the formation of concrete products. More particularly, the present disclosure is generally directed to a system for and method of preparing and pouring a concrete slurry for the formation of concrete products.

### BACKGROUND

Concrete products, such as concrete slabs (floor slabs, foundation slabs), concrete rafts, concrete pillars and columns, etc., are usually composed of unreinforced or reinforced concrete. The level of reinforcement generally is dictated by at least the intended use, the exposure to the elements, the load, and the loading intensities, amongst various other factors.

Reinforcement also is used to control cracking or fracturing, which is common throughout the useful life of a concrete product. Cracking or fracturing may be caused by shrinkage, flexing (flexural moment), substrate and foundation settlement, and punching-out of point loadings, amongst various other factors.

The cracks or fractures provide a path for evaporating molecules to escape. The cracks or fractures penetrate the concrete, which promote chemical erosive reactions within the concrete, and which cause corrosion of the reinforcement structures contained therein. The cracks also function as channels for liquid to seep deep into the concrete, to the point of saturation, which further erodes the concrete, via freeze (expansion) and thaw (constriction) cycles.

Various unsuccessful attempts have been made in the field to mitigate cracking or fracturing, to minimize the width of the cracks or fractures that do form, and to avoid various other problems. Solutions have been conceived to vary the composition of the concrete mixture, and/or to vary the methods of preparing the concrete mixture into a concrete slurry, and/or to vary the ballast material used in forming the final concrete product. These possible solutions; however, usually require a concrete formulation comprising expansive admixtures with the hope of countering the shrinkage of the concrete and the loss of water. In these solutions it is difficult to determine the proper amount of expansive admixtures required to counter the shrinkage.

The use of such unsuccessful solutions usually gives rise to unpredictable results; in particular, results requiring concrete-producing entities to employ one or more solutions to mitigate the risk of concrete slab failure. This adds unnecessary complexity and unforeseen consequences, as is described in greater detail herein.

As another unsuccessful solution, it is common to employ joint cutting techniques during formation of a concrete product. Joint cutting or joint-making in an already-placed concrete slab commonly is used to divide at least a portion of a thickness of a concrete slab into adjacent partitioned slabs, such that any shrinkage or contraction of the concrete is localized to the cut-line or joint and, thereby, will minimize such formations at other portions of the partitioned slab.

Cut joints may come in various forms such as saw-cutting a slab at 5.0 meters (m) to 15.0 m intervals at full or partial depth, or full-depth construction joints at similar intervals. Certain regulatory agencies have guidelines recommending joints at about 14.0 feet (′) distances for a 6 inch (″) thick slab, and at about 17.0′ distances for an 8′ thick slab. Shrinkage in the concrete along the cut joint ultimately will cause the joint to open and curl along the edges of the adjacent partitioned slabs, especially if the shrinkage is greater along the more-superficial (shallower) portions of concrete than along the more-profound (deeper) portions of concrete. The thinner the individual slab, the faster it will curl. This, however, is but one of various deficiencies in the joint-cutting process. Joints, for example, are commonly known to be expensive to install and are not applicable to the formation of certain concrete products such as vertical walls, columns, pillars, etc.

It is, therefore, desirable to overcome the deficiencies of and provide for improvements in the state of the prior art.

Improved methods, process, and systems in the formation of concrete products are discussed. As used herein, any reference to an object of the present invention should be understood to refer to solutions and advantages of the present invention, which flow from its conception and reduction to practice, and not to any a priori or prior art conception. A better understanding of the principles and details of the present invention will be evident from the following description.

### SUMMARY

Exemplary embodiments are directed to a system for, and a method of, forming concrete slabs and rafts, based on the synergistic combination of a uniquely prepared concrete mixture with a unique curing technique. Exemplary embodiments also are generally directed to a process for the formation of concrete products that is more efficient and effective, and that more readily complies with modern health and regulatory standards.

In one exemplary embodiment, a jointless concrete slab may be set by pouring a concrete slurry onto a substrate. The poured concrete slurry comprises a) a concrete mixture; b) a colloidal silica admixture; and c) at least one fiber selected from a group of fibers consisting of steel fibers and synthetic fibers. As the poured concrete slurry cures, the poured slurry hardens into a composite material taking the form of a jointless concrete slab, and the jointless concrete slab defines capillary structures that at least in part fill with silica particles and lime. The silica particles and lime react therein to produce a gel structure of calcium silicate hydrate that at least partially fills the capillary structures, and that reduces the internal tensile forces acting on the jointless concrete slab.

In another exemplary embodiment, the colloidal silica admixture is amorphous colloidal silica in an aqueous solution wherein the silica particles have a size ranging from between about 10.0 nanometers (nm) to about 100.0 nm. The concrete mixture comprises aggregate, cement, and water, wherein the concrete mixture is defined by a water to cement ratio of between about 0.400 to about 0.450. The at least one fiber selected from a group of fibers represents between about 0.25 percent (%) by volume to about 0.50% by volume of the poured concrete slurry, or more specifically between about 0.20% by volume to about 0.50% by volume of the poured concrete slurry. Further, the colloidal silica has silica particles having a size ranging from between about 5.0 nm to about 100 nm.

In another exemplary embodiment, the jointless concrete slab is set by pouring a concrete slurry onto a substrate and then applying a curing technique to the poured and set concrete slurry. The curing technique comprises spray-applying a secondary colloidal silica onto the poured and set concrete slurry. The silica particles of the secondary colloidal silica have a size ranging from about 10.0 nm to about 50.0 nm. The spray-applied colloidal silica can be applied using pump sprayers, walk-behind electric-powered “turf” sprayers, and the like, and includes all manner of spraying a liquid solution onto a surface.

In another exemplary embodiment, the present invention is directed to a process for placing a jointless concrete slab on a substrate. The process comprises the steps of a) preparing a concrete slurry comprising i) a concrete mixture; ii) a colloidal silica admixture; and iii) at least one fiber selected from a group of fibers consisting of steel fibers and synthetic fibers, b) pouring the concrete slurry onto the substrate; and c) allowing the concrete slurry to cure such that capillary structures develop as the concrete slab sets from the poured concrete slurry. The capillary structures of the slab at least in part fill with silica particles and lime, and the silica particles and lime react to produce a gel structure of calcium silicate hydrate that at least partially fill the capillary structures.

In an exemplary embodiment, the preparing step comprises preparing the concrete slurry with an amorphous colloidal silica admixture that is in an aqueous solution. The preparing step also comprises adding the colloidal silica admixture to the concrete slurry in ranges of between about 0.50% to about 1.50% by weight of cement in the concrete mixture. The preparing step additionally comprises preparing the concrete slurry for pouring with dosages of steel fibers as the at least one fiber selected from a group of fibers of between about 33.0 pounds per cubic yard (lbs./cuyd) to about 66.0 lbs./cuyd. The preparing step additionally comprises preparing the concrete slurry for pouring with dosages of macro synthetic fibers as the at least one fiber selected from a group of fibers of between about 3.0 lbs./cuyd to about 7.5 lbs./cuyd.

In another exemplary embodiment, the process additionally comprises the step of spray-applying a secondary colloidal silica onto the poured concrete slurry to facilitate curing thereof. The spray-applying step comprises spray-applying the secondary colloidal silica onto the poured concrete slurry subsequent to removal of a trowel machine, and prior to cement in the poured concrete slurry being completely set, or subsequent to cement in the poured concrete slurry being completely set.

In another exemplary embodiment, a jointless concrete slab is provided. The jointless concrete slab is set from a concrete slurry poured onto a substrate, the poured concrete slurry comprising a concrete mixture, a colloidal silica admixture, and at least one fiber selected from a group of fibers consisting of steel fibers and synthetic fibers, the jointless concrete slab comprising capillary structures that are at least in part filled with a reaction product of silica particles and lime, the reaction product being a gel structure of calcium silicate hydrate, whereby the calcium silicate hydrate reduces internal tensile forces acting on the jointless concrete slab.

In another exemplary embodiment, a jointless fiberless concrete slab is set by pouring a concrete slurry onto a substrate. The poured concrete slurry comprises a) a concrete mixture; and b) a colloidal silica admixture but no fibers. As the poured concrete slurry cures, the poured concrete slurry hardens into a composite material taking the form of a jointless concrete slab, and the jointless concrete slab defines capillary structures that at least in part fill with silica particles and lime.

In another exemplary embodiment, the jointless fiberless concrete slab also is set by pouring the concrete slurry onto the substrate and then spray-applying a secondary colloidal silica, having a particle size ranging from about 10.0 nm to about 50.0 nm, or from about 3.0 nm to about 50 nm, onto the poured concrete slurry.

In another exemplary embodiment, a process for placing a jointless fiberless concrete slab on a substrate is provided. The process comprises the steps of a) preparing a concrete slurry comprising i) a concrete mixture and ii) a colloidal silica admixture; b) pouring the concrete slurry onto the substrate; and c) allowing the concrete slurry to cure such that capillary structures develop, such that silica particles and lime partially fill those capillaries and react to produce a gel structure of calcium silicate hydrate.

The preparing step comprises preparing the concrete slurry with amorphous colloidal silica that is in an aqueous solution. The preparing step comprises adding the colloidal silica admixture to the concrete slurry in ranges of between about 0.5% to about 10.0% by weight of cement in the concrete mixture.

In another exemplary embodiment, a jointless fiberless concrete slab is set from a concrete slurry poured onto a substrate, the poured concrete slurry comprising a concrete mixture and a colloidal silica admixture, the jointless concrete slab comprising capillary structures that are at least in part filled with a reaction product of silica particles and lime, the reaction product being a gel structure of calcium silicate hydrate, whereby the calcium silicate hydrate reduces internal tensile forces acting on the jointless concrete slab.

### BRIEF DESCRIPTION OF THE DRAWINGS

FIG. 1 is a perspective view of an exemplary jointless concrete slab.

FIG. 2 is a magnified perspective view of a cut-away portion of the jointless concrete slab of FIG. 1.

FIG. 3 is a flow diagram showing the steps of a first illustrative embodiment of a method for placing a jointless concrete slab on a substrate.

FIG. 4 is a flow diagram showing the steps of a second illustrative embodiment of a method for placing a jointless concrete slab on a substrate.

FIG. 5 is a flow diagram showing the steps of a third illustrative embodiment of a method for placing a jointless concrete slab on a substrate.

FIG. 6 is a flow diagram showing the steps of a fourth illustrative embodiment of a method for placing a jointless concrete slab on a substrate.

FIG. 7 is a perspective view of an exemplary jointless and fiberless concrete slab.

### DETAILED DESCRIPTION

For a further understanding of the nature, function, and objects of the present invention, reference should now be made to the following detailed description. While detailed descriptions of the preferred embodiments are provided herein, as well as the best mode of carrying out and employing the present invention, it is to be understood that the present invention may be embodied in various forms. Specific details disclosed herein are not to be interpreted as limiting but rather as a basis for the claims and as a representative basis for teaching one skilled in the art to employ the present invention in virtually any appropriately detailed system, structure, or manner.

For purposes of this disclosure, a “jointless” concrete slab refers to a slab that does not have cut joints and that is capable of managing the cracks and fractures without the cut joints. Percent (%) by weight refers to the aggregate weight of the silica particles in comparison to the final weight of cement in a final concrete product. A “fiberless” concrete slab refers to a slab that does not have steel fibers, synthetic fibers, or other like internal reinforcements, and that still remains capable of managing the cracks and fractures without the fibers.

Embodiments and aspects of the present disclosure provide a system for, and method of, preparing and pouring a concrete slurry for the formation of concrete products, which are not susceptible to the limitations and deficiencies of the prior art. The inventive concepts described herein allow for the formation, in certain non-limiting embodiments, of concrete slabs and rafts, based on the synergistic combination of a prepared concrete slurry with a curing technique. Further, the inventive concepts described herein also allow for the formation, in certain non-limiting embodiments, of concrete products that are less susceptible to cracking or fracturing, and that are less susceptible to the complications derived therefrom.

The inventive concepts described herein also allow for a decreased need for and a decreased use of traditional reinforcements such as rebar and/or mattings. This allows for efficiencies in time, labor, and resources, and allows for a streamlining and simplifying of the process for forming and maintaining a concrete product.

As further background and context: throughout the United States of America, the large majority of concrete slabs are installed with a pattern of saw-cuts configured as joints. The joints control the inherent drying, shrinking, and cracking that occurs in the concrete. The American Concrete Institute™ (ACI) standards for a 1,000,000 square foot industrial warehouse with a 6″ slab will define approximately 25 miles of control joints. If concrete slabs-on-ground are designed per ACI Guide ACI 360R-10, typical concrete mixtures, such as 4,000 pounds per square inch (psi) 28-day compressive strength mixtures, are expected to shrink about ⅜″ to ½″ per 100 feet while drying/curing.

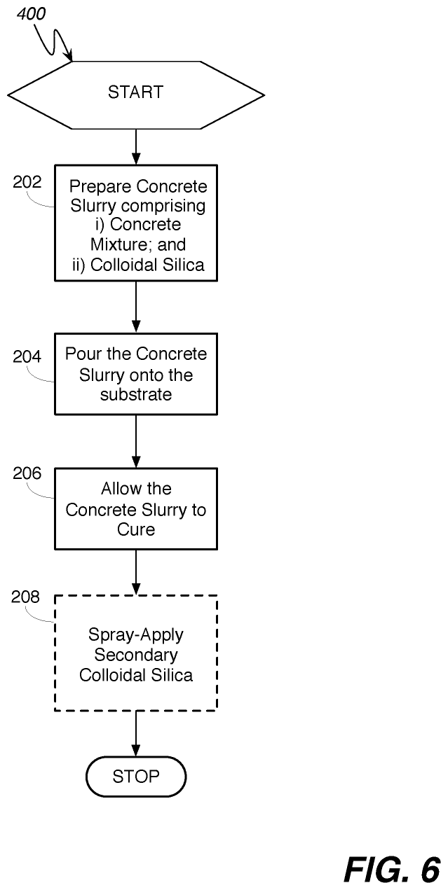

A person having ordinary skill in the art quickly realizes that such solutions are complex, complicated, and resource intensive. In one example, ACI 360R-10 calls for the installation of doweled joints to provide adequate load transfer between adjacent slabs, especially, if load transfer, due to frequent “rolling traffic”, is expected. In another instance, guidelines for joint spacing are given in ACI 360R-10 Chapter 6, FIG. 6.6, wherein the graph shows joints for a typical concrete slab at about 14.0′ distances for 6″ thick floors and about 17.0′ joint distances for 8″ thick floor.

While these may appear to be adequate solutions to the shrinking/cracking problem, the current state of the art indicates the opposite. The practice of saw-cutting modern concrete, and cutting the control joints, causes other issues such as curling, spalling, joint/joint filing maintenance, limited rack post layout options for warehouses, increased wear/tear on surface equipment (e.g. automobiles, forklifts, robotic equipment), and increased injury to workers, to name a few. These are examples of how current prior art solutions give rise to unpredictable results, and how the common teachings in the art—steering concrete-product producing entities to employ one or more solutions—adds unnecessary complexity and unforeseen consequences.

Due to the latest safety and health regulations in the United States of America for silica exposure, there is a significant cost to concrete-product producing businesses stemming from risk-mitigation practices (e.g., vacuuming, containment, collection, disposal) during the saw-cutting process, in order to contain the hazardous pozzolan dust and other additive-dust produced therefrom.

Concern for these risk-mitigation practices, and other possible future unpredictable results, is not unwarranted. Type F Fly Ash is the most common artificial pozzolan and is derived from coal combustion. The amorphous glassy spherical morphology of the particle provides the pozzolanic activity and is a respiratory hazard, not accounting for any other contaminants in the fly ash.

Silica fume is a waste product of the silicon metal industry, usually retrieved from the stack gases of electric arc furnaces, and is a microparticulate of almost pure amorphous silica. Silica fume is notoriously difficult and expensive to handle, transport and mix, as it is a light, fluffy, possibly air-born material (almost as fine as cigarette ash, with a bulk density of about between 200.0 kilograms per meter cubed (kg/m\hat{ }3) to about 300.0 kg/m\hat{ }3, and a relative density of between about 2.20 to about 2.50). Despite its drawbacks, it has become a standard additive in the art for high-strength concretes, and is often used in combination with both cement and fly ash.

Contributing to this potential hazard, silica fume usually is a by-product resulting from the production of silicon or ferrosilicon metal alloys or other silicon alloys, or derived from the pyrolysis of rice hulls, metakaolin, etc. Silica fume typically contains about 90% of amorphous silicon dioxide depending on the source. Undensified silica fume consists of very fine vitreous spherical particles with an average diameter of about 150.0 nm, whereas the average cement particle has a diameter of about 10.0 um. Because of its extreme fineness and high silicon content, silica fume also is generally a very effective pozzolan but also is known as a respiratory hazard, not accounting for any contaminants in the fume.

Although seamless concrete slabs are prevalent in Europe, with little to no production of dusts, etc. to mitigate against, the vast majority of the slabs are steel-fiber reinforced and without shrinkage reducing admixtures (SRAs) and without complicated cement formulations. Under these circumstances, the common teachings in the art steer concrete-product producing businesses to keep the concrete formulations simple; however, they rely on already-deficient techniques from the past to compensate. The deficiencies of these solutions are described in greater detail as background and context information; however, a person having ordinary skill in the art understands that slabs using these prior art composite-concrete compositions possess the following deficiencies: (1) size restrictions based on the internal reinforcement; (2) need for maintenance and inspection of reinforcements; (3) more complicated engineering and higher material costs and demands; and (4) a higher minimum thickness of the slab due to the added internal reinforcements, etc.

In the United States of America, there are few industrial slab installations without joints. Most of these industrial slab installations without joints use a shrinkage-compensating concrete comprising a Type K cement incorporating a calcium sulfoaluminate additive. This Type K cement, which is one example of the broader field of expansive cements, is used in combination with rebar or steel fibers to help restrain the cement as it expands. These expansive cements also require at least a 7-day wet cure to ensure that the designed expansion occurs. In short, this technique results in a concrete product with high internal expansion, which puts the concrete under intense internal compression. This is done to combat the inherent shrinkage of traditional concrete and yet still has many inherent deficiencies understood by a person having ordinary skill in the art.

With the above context in mind, a first exemplary embodiment of the inventive concepts provides a system for, and method of, preparing and pouring a concrete slurry for the formation of concrete products, wherein micro- and/or nano-particles and/or fibers are paired with a durable and flexible blend of aggregates, pastes, and admixtures, to provide an impermeable jointless and/or fiberless mass of concrete exhibiting exceptional tensile strength and durability for the heaviest loads and equipment.

A second exemplary embodiment provides a system for, and method of, forming of a concrete product via a concrete slurry and curing and/or finishing technique, wherein the concrete slurry leverages colloidal silica in combination with fibers (steel and/or macro synthetic, for example) to create a jointless mass. The colloidal silica is used as an admixture and/or sprayed onto the surface as a “cure” soon after or right after the trowel machine is removed.

For this particular embodiment, a 7-day wet cure common for a poured concrete slurry for a similar application or use is not required. The colloidal silica works to fill the capillary structure to reduce internal tensile forces, which drastically reduces the likelihood of shrinking and cracking of the concrete. Spraying the surface of the poured concrete slurry with the colloidal silica at the appropriate time and dosage as described herein has been found by the inventor to be similar to a 28-day wet cure, in that open capillaries are filled with reactive nanometer-sized silica particles that react with the free lime to produce a stable gel structure of calcium silicate hydrate, which eliminates moisture loss by plugging the pores of the capillary structures. The inventor has also found that this process is not temporary, and is instead a permanent solution. The calcium silicate hydrate is the foundation of the concrete.

At this high-level non-limiting example, the use of colloidal silica as an admixture and/or spray works with the internal cement molecule. Colloidal silica, which is included within the category of pozzolans, is a suspension of fine amorphous, nonporous, and typically spherical silica particles in a liquid phase. During curing and thereafter, the colloidal silica will react with free lime, increasing the density and structural strength of the solid structures formed. The increased density and long-term pozzolanic action ties up free lime, which limits the creation of channels and decreases the permeability in the concrete structure. Moreover, the resultant chemical and structural effect also helps keep contaminants and particles on the surface of the concrete.

A third exemplary embodiment provides a process for placing a jointless concrete slab on a substrate for industrial and commercial applications. The applications on the surface of the slab may involve automated facilities with laser-guided equipment moving on the slab, where even the slightest imperfection in the slab can bring the whole facility to a stand-still. The slab is characterized by being virtually free of curling and cracking, and having superior abrasion-resistance. The slab also is characterized by having higher than normal resistance to the effects of aggressive water and chemical attack, such as salt, when compared to traditional concrete composite materials. The slab also provides a highly dense, highly accurate, and planar concrete surface with limited internal macro-reinforcements and a thinner cross section than a conventional concrete slab of the same strength.

For this particular embodiment, the process comprises: (1) preparing a concrete slurry with a water to cement ratio of between about 0.400 to about 0.450, with steel fibers or macro synthetic fibers, or a combination of these fibers, (2) preparing the concrete slurry with a colloidal silica, integral thereto, (3) performing a “spray-apply” step using colloidal silica, and (4) providing reaction and performance enhancing chemicals to the slurry or to the curing/to-be finished product. The overall process comprises establishing a highly accurate, and well compacted subbase preparation as a foundation in preparation for placement of the concrete.

A fourth exemplary embodiment provides a method comprising the step of using steel fibers to mitigate shrinkage cracks in the concrete. Fibers help mitigate plastic and drying shrinkage by arresting the movement of the concrete slab and distributing any shrinkage across the entire slab and fiber network area by means of micro cracking, i.e., when shrinkage occurs the fibers engage and redistribute the shrinkage. This holds true for both steel and macro-synthetic fibers, as described in greater detail herein.

This step may be one step in a series of steps making up an exemplary embodiment. As is described in greater detail herein, shrinkage cracks occur either as early plastic shrinkage, nucleating in the first 24 hours while the concrete has low strength, or nucleating as late cracks, due to the external restraint of the volume change during the drying shrinkage. As water is lost in the cement paste, shrinking places the aggregates in compression. Fine and discrete cracks nucleate and extend from the perimeter of the aggregates, and the numerous fine cracks continue to extend, while shrinkage increases over time and the cracks coalesce. As the concrete slab shrinks, the concrete slab shortens in all directions. The microcracks then combine at the location of the greatest strain and stress, where subsequently a crack will form.

For this particular embodiment, the step of using steel fibers to mitigate shrinkage cracks in the concrete allows for fibers to be randomly distributed throughout the concrete slab and can, with close spacing and good bonding, intercept the formation of cracks. Different types of steel fibers may be used for different applications. Some Type 2 steel fibers are sized to number about 9000.0 fibers per pound (lb.) and are used typically in dosages of about 33.0 lbs./cuyd (representing about 0.250% by volume of concrete) to about 66.0 lbs./cuyd (representing about 0.50% by volume of concrete). Some Type 1 steel fibers are sized and number about 2500.0 fibers per pound and may also be used.

A fifth exemplary embodiment provides a method comprising the step of using macro synthetic fibers to mitigate shrinkage cracks in concrete. This step may be one step in a series of steps making up an exemplary method of the present invention. The effect of the macro synthetic fibers is similar to the step of using steel fibers to mitigate shrinkage cracks in the concrete. However, the step of using macro synthetic fibers to mitigate shrinkage cracks in concrete also improves water retention and; therefore, assures a more complete hydration of the cement, and may also reduce plastic shrinkage more effectively than steel fibers in some circumstances. Further, the high fiber count associated with the step of using macro synthetic fibers intercepts the formation of microcracks and, therefore, reduces the formation of larger cracks. The macro synthetic fibers also may be added to the concrete in dosage rates of about 3.0 lbs./cuyd representing about 0.20% by volume of concrete to about 7.50 lbs./cuyd, representing about 0.50% by volume of concrete.

A sixth exemplary embodiment provides a method comprising the step of using or adding colloidal silica to the slurry. This step may be one step in a series of steps making up an exemplary method of the present invention. Amorphous colloidal silica is in an aqueous solution, with nanometer-sized silica (SiO₂) in a particle size ranging from between about 10.0 nm to about 100.0 nm, or from between about 5.0 nm to about 100.0 nm, and is added to the concrete slurry along with reaction enhancing and workability enhancing (rheology enhancing) admixtures, such as polycarboxylate. The silica will react with the free lime or calcium hydroxide (Ca(OH)₂) from the cement hydration to form a solid gel product called CSH, or calcium silicate hydrate (CaSiO₃+H₂O).

For this particular embodiment, as is shown in the following Formula 1:

Ca(OH)₂+SiO₂⇔CaSiO₃+H₂O (1)

, the colloidal silica aqueous solution is added to the concrete during the preparation phase in ranges of between about 0.50% to about 1.50% by weight of cement, depending on the concrete slurry design and the application. The above described chemical reaction will consume some of the capillary water and will fill the pores with the hydration products CSH and, therefore, greatly reduce drying shrinkage.

A seventh exemplary embodiment provides a method comprising the step of using the spray-applied colloidal silica as a curing technique. This step may be one step in a series of steps making up an exemplary method of the present invention. Amorphous colloidal silica with particle sizes of between about 10.0 nm to about 50.0 nm in an aqueous solution is sprayed on a surface of the finished concrete slab after final set of the cement, or as described in greater detail herein. The nanometer-sized particles penetrate up to about 3.0″ deep into the hardened concrete after between about 3.0 to about 6.0 hours after the final set of cement and react with the capillary pore water and available calcium hydroxide to form CSH, calcium silicate hydrate, as described herein. This also will seal the top of the concrete and prevent water from evaporating from the concrete mixture and thus enhance the cement hydration process. The spray-applied colloidal silica can be applied using a pump sprayer, a walk-behind electric-powered “turf” sprayer, and the like, as well as custom-made automated spraying machines. The entire surface of the slab is sprayed such that the nanometer-sized particles penetrate and complete the filling of the capillary structures. This process step of spray-applying colloidal silica may occur after the concrete has been trowel finished and can be walked on without imprinting the surface.

An eighth exemplary embodiment provides a system for, and a method of, preparing and pouring a concrete slurry with colloidal silica, as described herein, for the formation of concrete products, wherein a polycarboxylate ether-based superplasticizer admixture is paired with the cement mixture, colloidal silica admixture, and/or the secondary spray-applied silica, to provide an impermeable jointless and/or fiberless mass of concrete. With a relatively low dosage (0.15-0.30% by weight of cement), a polycarboxylate ether-based superplasticizer allows water reduction due to its chemical structure, which enables good particle dispersion. Polycarboxylate ether-based superplasticizers are composed of a methoxy-polyethylene glycol copolymer (side-chain) grafted with methacrylicacid copolymer (main-chain). The carboxylate group —COO—Na+ dissociates in water, providing a negative charge along the polycarboxylate ether-based superplasticizer backbone. The polycarboxylate ether-based superplasticizer backbone, which is negatively charged, permits the adsorption on the positively charged colloidal particles. As a consequence of PCE adsorption, the zeta potential of the suspended particles changes, due to the adsorpsion of the COO— groups on the colloid surface. This displacement of the polymer on the particle surface provides the side chains the opportunity to exert repulsion forces, which disperse the particles of the suspension and helps avoid friction.

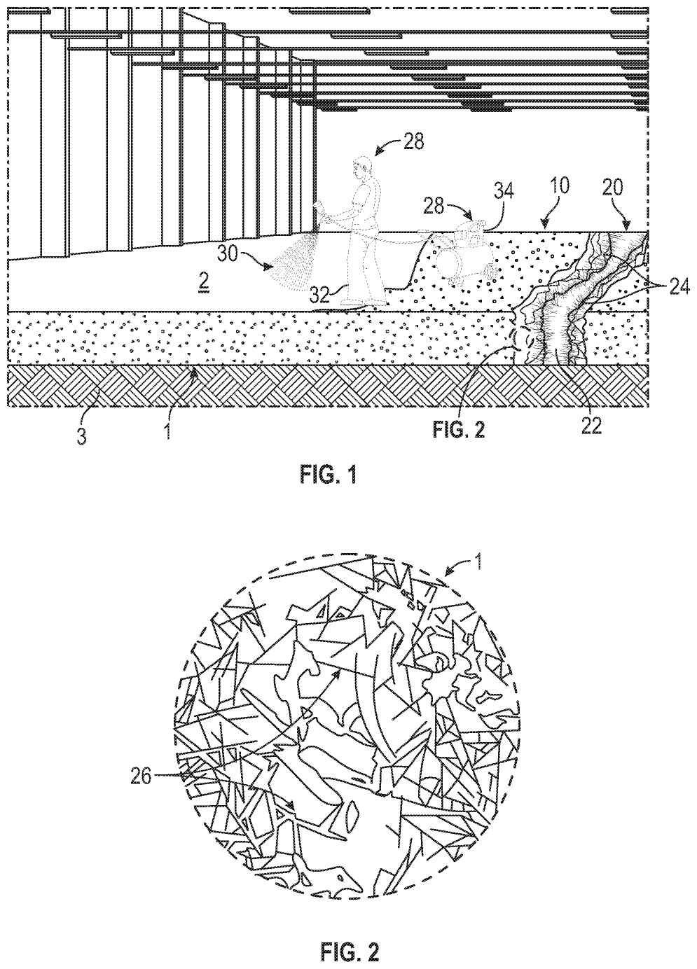

FIG. 1 shows a perspective view of an exemplary jointless slab 1. The jointless slab 1 of FIG. 1 is shown placed in warehouse-type setting according to an exemplary embodiment. The jointless slab 1 is placed on top of a leveled and compacted substrate 3 and is for industrial and commercial applications in this exemplary embodiment. As a non-limiting example, applications that will be placed on or occur on top of the jointless slab 1 may involve automated facilities with laser-guided equipment moving on the jointless slab 1, where even the slightest imperfection can bring the whole facility to a stand-still. The jointless slab 1 is characterized by being virtually free of curling and cracking, and having superior abrasion-resistance.

The jointless slab 1 is illustrated in partial cut-away form to show layers of internal composition and structure of the composite material. The first cut-away section 10 illustrates the sub-surface, below the curing/to-be finished exterior 2. The sub-surface of the first cut-away section 10 is porous, unfinished and rough. The second cut-away section 20 illustrates the jointless slab 1 having a crack 22 to expose the internal composition of the composite material of the jointless slab 1. In particular, the jointless slab 1 comprises hardened aggregate and cement as well as one or more of steel fibers and macro synthetic fibers 24. However, in other exemplary embodiments, the jointless slab 1 may be made without such steel fibers and/or macro synthetic fibers. The hardened aggregate and cement, as well as steel fibers and macro synthetic fibers 24 if such fibers are included, at least in part define capillary structures 26 (best seen in FIG. 2) throughout the jointless slab 1. In an exemplary embodiment, capillary structures 26 (FIG. 2) are filled with reactive nanometer-sized silica particles that react with free lime to produce a stable gel structure of calcium silicate hydrate within the capillary structures 26.

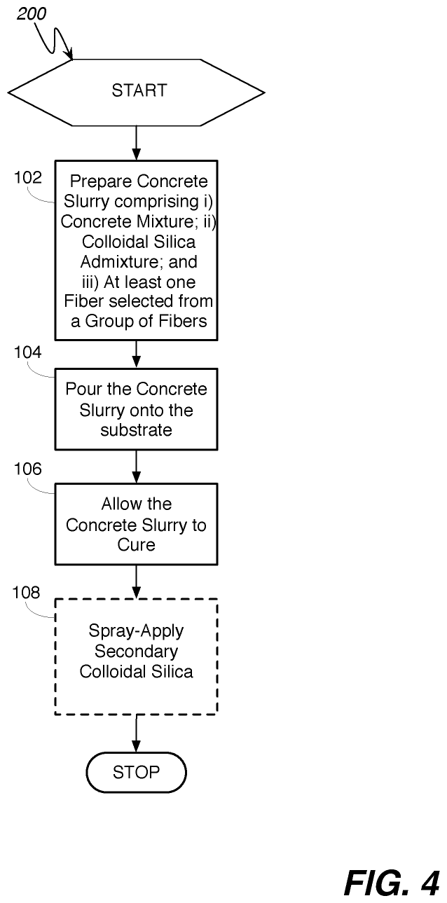

The jointless slab 1 is illustrated with an optional and exemplary spray-apply system 28. The system 28 may also be used for spray-applying a secondary colloidal silica 30 as described herein (see FIG. 4 and FIG. 6). The system 28 comprises an optional human operator 32 using an exemplary embodiment of a spraying machine 34. The system 28 is optionally used after a concrete slurry of the present invention is poured, trowel finished, and can be walked on by the human operator 32, without imprinting the surface of the hardening jointless slab 1. The system 28 optionally sprays the entire surface of the jointless slab 1 to saturation such that the nanometer-sized colloidal silica particles in the secondary silica spray 30 can penetrate and complete the filling of the capillary structures 26.

FIG. 2 is a magnified perspective view of the crack 22 along the second cut-away section 20 of the jointless slab 1 of FIG. 1. The magnified section of FIG. 1 illustrated in FIG. 2 shows a view of the intersection of the hardened aggregate and cement as well as steel fibers and macro synthetic fibers 24, if included, that at least in part define the capillary structures 26 of the jointless slab 1.

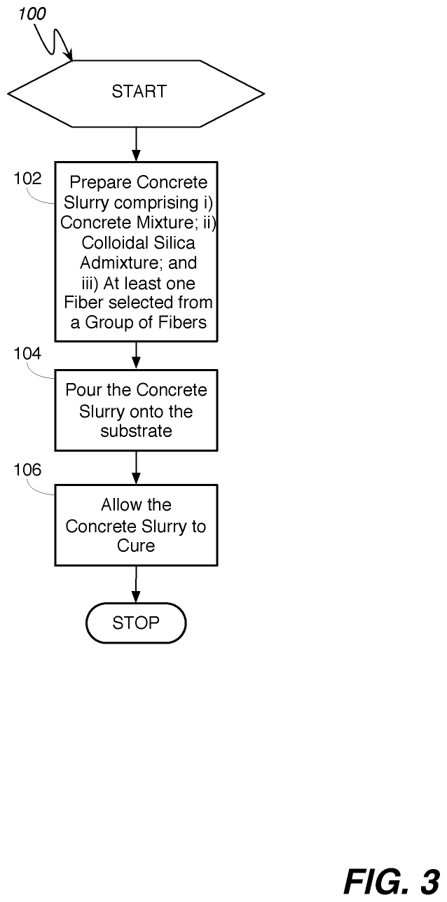

FIG. 3 is a flow diagram of a first illustrative method 100 according to an exemplary embodiment. The method 100 discloses steps, not all of which are necessarily employed in each and every situation, but which may have similarities to other exemplary embodiments provided herein. The steps in the method 100 may be performed in or out of the order shown. The method 100 comprises the steps of: preparing a concrete slurry comprising i) a concrete mixture; ii) a colloidal silica admixture; and iii) at least one fiber selected from a group consisting of fibers selected from steel fibers and synthetic fibers (102); pouring the concrete slurry onto the substrate (104); and allowing the concrete slurry to cure (106), such that capillary structures develop as the concrete slab sets from the poured concrete slurry, and such that the capillary structures of the slab at least in part fill with silica particles and lime, and such that the silica particles and lime react to produce a gel structure of calcium silicate hydrate that at least partially fill, respectively, the capillary structures.

In some exemplary embodiments, the preparing step 102 of method 100 comprises preparing the concrete slurry with amorphous colloidal silica that is in an aqueous solution and that comprises silica particles having a size ranging from between about 10.0 nm to about 100.0 nm, or from between about 5.0 nm to about 100 nm. In another embodiment, the preparing step 102 additionally comprises adding the colloidal silica admixture to the concrete slurry in ranges of between about 0.50% to about 1.50% by weight of cement in the concrete mixture, wherein % by weight refers to the aggregate weight of the silica particles in comparison to the final weight of cement in the final concrete product. In another embodiment, the preparing step 102 additionally comprises preparing the concrete slurry for pouring with dosages of steel fibers as the at least one fiber selected from a group of fibers of between about 33.0 lbs./cuyd to about 66.0 lbs./cuyd. In another embodiment, the preparing step 102 additionally comprises preparing the concrete admixture for pouring with dosages of macro synthetic fibers as the at least one fiber selected from a group of fibers of between about 3.0 lbs./cuyd to about 7.5 lbs./cuyd.

FIG. 4 is a flow diagram of a second illustrative method 200 according to an exemplary embodiment. Some of the steps of the method 200 are identical to the steps in the method 100 of FIG. 3; therefore, only the differences in the method 200 are detailed herein. The method 200 additionally comprises the step 108 of spray-applying a secondary colloidal silica onto the poured concrete slurry to facilitate curing thereof. The spray-applying step 108 comprises spray-applying the secondary colloidal silica onto the poured concrete slurry subsequent to removal of a trowel machine and prior to cement in the poured concrete slurry being completely set. The spray-applying step 108 may comprise in other embodiments spray-applying the poured concrete slurry with an amorphous secondary colloidal silica in an aqueous solution having silica particles with size ranging from about 10.0 nm to about 50.0 nm, or from about 3.0 nm to about 50.0 nm, wherein the colloidal solution has a particle weight that ranges from about 5.0 to 20.0%, and wherein the coverage rate is about 250 gallons of colloidal solution per square foot, or from about 100.0 to about 500.0 gallons per square foot. The spray-applying step 108 also may comprise spray-applying the secondary colloidal silica onto the poured concrete slurry subsequent to cement in the poured concrete slurry being completely set, and spray-applying to the point of saturation or “flooding state” as is known in the art.

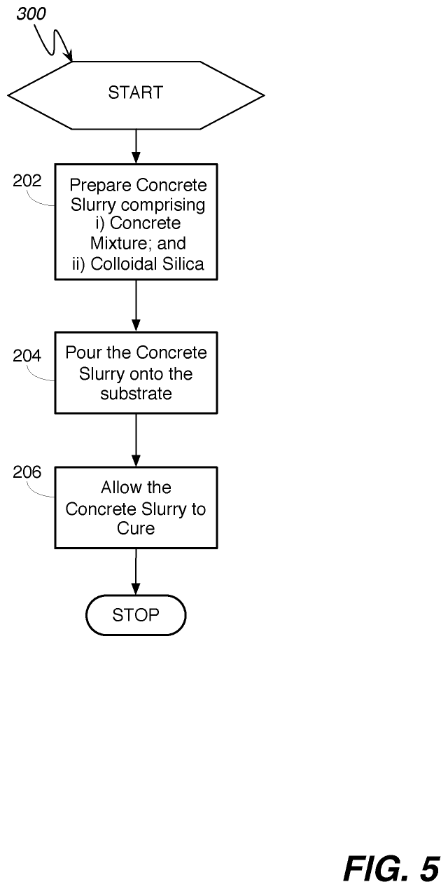

FIG. 5 is a flow diagram of a third illustrative method 300 according to an exemplary embodiment. In an exemplary embodiment the method 300 comprises the steps of: preparing a concrete slurry comprising i) a concrete mixture and ii) a colloidal silica admixture (202); pouring the concrete slurry onto the substrate (204); and allowing the concrete slurry to cure (206), such that capillary structures develop as the concrete slab sets from the poured concrete slurry, and such that the capillary structures of the slab at least in part fill with silica particles and lime, and such that the silica particles and lime react to produce a gel structure of calcium silicate hydrate that at least partially fill, respectively, the capillary structures.

In some exemplary embodiments, similar to those described for FIGS. 3 and FIG. 4, the preparing step 202 of method 200 comprises preparing the concrete slurry with amorphous colloidal silica that is in an aqueous solution and that comprises silica particles having a size ranging from between about 10.0 nm to about 100.0 nm, or from between about 5.0 nm to about 100 nm. In another embodiment, the preparing step 202 additionally comprises adding the colloidal silica admixture to the concrete slurry in ranges of between about 0.50% to about 10.0% by weight of cement in the concrete mixture.

FIG. 6 is a flow diagram of a fourth illustrative method 400 according to an exemplary embodiment. Some of the steps of the method 400 are identical to steps in the method 300 of FIG. 5; therefore, only the differences in the method 400 are detailed herein. The method 400 additionally comprises the step 208 of spray-applying a secondary colloidal silica onto the poured concrete slurry to facilitate curing thereof. The spray-applying step 208 comprises spray-applying the secondary colloidal silica onto the poured concrete slurry subsequent to removal of a trowel machine and prior to cement in the poured concrete slurry being completely set. The spray-applying step 208 comprises spray-applying the poured concrete slurry with an amorphous secondary colloidal silica in an aqueous solution having silica particles with size ranging from about 10.0 nm to about 50.0 nm, or from about 3.0 nm to about 50.0 nm. The spray-applying step 208 comprises spray-applying the secondary colloidal silica onto the poured concrete slurry subsequent to cement in the poured concrete slurry being completely set.

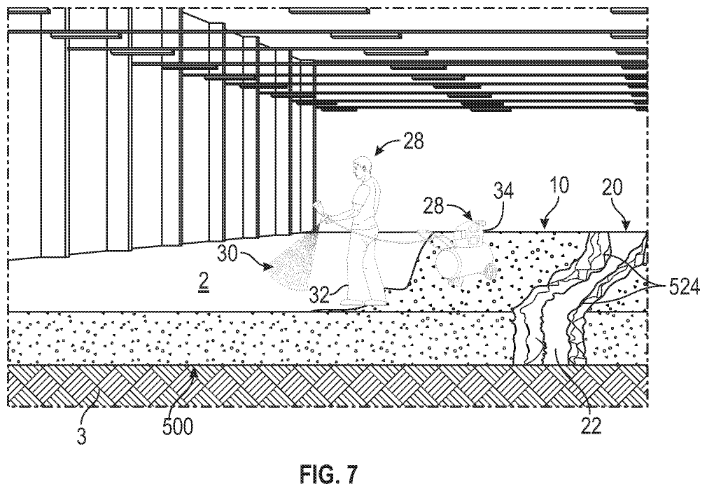

FIG. 7 shows a perspective view of an exemplary jointless and fiberless slab 500. The jointless and fiberless slab 500 is similar to the jointless slab 1 of FIG. 1; therefore, only the differences in the jointless and fiberless slab 500 are detailed herein.

The jointless and fiberless slab 500 is illustrated in partial cut-away form to show layers of internal composition and structure of the composite material. The second cut-away section 20 illustrates the jointless and fiberless slab 500 having a crack 22 to expose the internal composition of the composite material of the jointless and fiberless slab 500. In particular, the jointless and fiberless slab 500 comprises hardened aggregate and cement 524 without steel fibers and/or macro synthetic fibers. The hardened aggregate and cement 524 at least in part define capillary structures 26 (FIG. 2) throughout the jointless and fiberless slab 500, and the capillary structures 26 (FIG. 2) are filled with reactive nanometer-sized silica particles that react with free lime to produce a stable gel structure of calcium silicate hydrate within the capillary structures 26 (FIG. 2). An optional spray-apply system 28 may be used for spray-applying a secondary colloidal silica 30 on the entire surface of the jointless and fiberless slab 500 to saturation such that the nanometer-sized colloidal silica particles in the secondary silica spray 30 can penetrate and complete the filling of the capillary structures 26.

In one or more exemplary embodiments described herein, the systems and methods described may be implemented in various ways using various methodologies. Although selected aspects have been illustrated and described in detail, it will be understood that various substitutions and alterations may be made therein without departing from the spirit and scope of the present invention, as defined by the following claims.

What is claimed is:

1. A jointless concrete slab set by pouring a concrete slurry onto a substrate, the poured concrete slurry comprising:
a) a concrete mixture;
b) a colloidal silica admixture; and
c) at least one fiber selected from the group of fibers consisting of steel fibers and synthetic fibers;
wherein, as the poured concrete slurry cures, the poured slurry hardens into a composite material taking the form of a jointless concrete slab, the jointless concrete slab defining capillary structures that at least in part fill with silica particles and lime, and wherein the silica particles and lime react to produce a gel structure of calcium silicate hydrate that at least partially fill the capillary structures;
whereby the calcium silicate hydrate reduces internal tensile forces acting on the jointless concrete slab.

2. The jointless concrete slab of claim 1, wherein the colloidal silica admixture is an amorphous colloidal silica in an aqueous solution, and wherein silica particles have a size ranging from between about 10.0 nanometers (nm) to about 100.0 nm.

3. The jointless concrete slab of claim 1, wherein the jointless concrete slab is set by pouring the concrete slurry onto the substrate and then applying a curing technique to the poured concrete slurry, and wherein the curing technique comprises spray-applying a secondary colloidal silica onto the poured concrete slurry.

4. The jointless concrete slab of claim 3, wherein the secondary colloidal silica also is spray-applied onto the poured concrete slurry subsequent to removing a trowel machine.

5. The jointless concrete slab of claim 3, wherein the secondary colloidal silica is an amorphous colloidal silica in an aqueous solution, and wherein silica particles of the secondary colloidal silica have a size ranging from about 10.0 nm to about 50.0 nm.

6. The jointless concrete slab of claim 3, wherein the secondary colloidal silica is spray-applied onto the poured concrete slurry subsequent to cement in the poured concrete slurry being set.

7. The jointless concrete slab of claim 1, wherein the concrete mixture comprises aggregate, cement, and water, and wherein the concrete mixture is defined by a water to cement ratio of between about 0.400 to about 0.450.

8. The jointless concrete slab of claim 1, wherein the at least one fiber selected from the group consisting of steel fibers and synthetic fibers represents between about 0.25% by volume to about 0.50% by volume of the poured concrete slurry.

9. The jointless concrete slab of claim 1, wherein the at least one fiber selected from the group consisting of steel fibers and synthetic fibers represents between about 0.20% by volume to about 0.50% by volume of the poured concrete slurry.

10. A process for placing a jointless concrete slab on a substrate, the process comprising:
a) preparing a concrete slurry, the concrete slurry comprising:
i) a concrete mixture;
ii) a colloidal silica admixture; and
iii) at least one fiber selected from the group of fibers consisting of steel fibers and synthetic fibers;
b) pouring the concrete slurry onto a substrate; and
c) allowing the concrete slurry to cure such that capillary structures develop as the jointless concrete slab sets from the poured concrete slurry, and such that the capillary structures of the slab at least in part fill with silica particles and lime, and such that the silica particles and lime react to produce a gel structure of calcium silicate hydrate that at least partially fill the capillary structures.

11. The process for placing a jointless concrete slab of claim 10, wherein the preparing step comprises preparing the concrete slurry with amorphous colloidal silica admixture that is in an aqueous solution and that comprises silica particles having a size ranging from between about 10.0 nm to about 100.0 nm.

12. The process for placing a jointless concrete slab of claim 11, wherein the preparing step additionally comprises adding the colloidal silica admixture to the concrete slurry in ranges of between about 0.50% to about 1.50% by weight of cement in the concrete mixture.

13. The process for placing a jointless concrete slab of claim 10, additionally comprising the step of spray-applying a secondary colloidal silica onto the poured concrete slurry to facilitate curing thereof.

14. The process for placing a jointless concrete slab of claim 13, wherein the spray-applying step comprises spray-applying the secondary colloidal silica onto the poured concrete slurry subsequent to removal of a trowel machine and prior to cement in the poured concrete slurry being completely set.

15. The process for placing a jointless concrete slab of claim 13, wherein the spray-applying step comprises spray-applying the poured concrete slurry with an amorphous secondary colloidal silica in an aqueous solution having silica particles with size ranging from about 10.0 nm to about 50.0 nm.

16. The process for placing a jointless concrete slab of claim 13, wherein the spray-applying step comprises spray-applying the secondary colloidal silica onto the poured concrete slurry subsequent to cement in the poured concrete slurry being set.

17. The process for placing a jointless concrete slab of claim 10, wherein the preparing step comprises preparing the concrete slurry for pouring with dosages of steel fibers as the at least one fiber selected from the group of fibers of between about 33.0 pounds per cubic yard (lbs./cuyd) to about 66.0 lbs./cuyd.

18. The process for placing a jointless concrete slab of claim 10, wherein the preparing step comprises preparing the concrete slurry for pouring with dosages of macro synthetic fibers as the at least one fiber selected from the group of fibers of between about 3.0 lbs./cuyd to about 7.5 lbs./cuyd.

19. A jointless concrete slab set from a concrete slurry poured onto a substrate, the poured concrete slurry comprising a concrete mixture, a colloidal silica admixture, and at least one fiber selected from the group of fibers consisting of steel fibers and synthetic fibers, the jointless concrete slab comprising capillary structures that are at least in part filled with a reaction product of silica particles and lime, the reaction product being a gel structure of calcium silicate hydrate, whereby the calcium silicate hydrate reduces internal tensile forces acting on the jointless concrete slab.

20. The jointless concrete slab of claim 19, wherein the colloidal silica admixture is an amorphous colloidal silica in an aqueous solution, and wherein silica particles have a size ranging from between about 10.0 nm to about 100.0 nm.

21. The jointless concrete slab of claim 19, wherein the jointless concrete slab is set from the concrete slurry and cured by application of a spray-applied secondary colloidal silica, whereby the secondary colloidal silica facilitates curing of the poured concrete slurry.

22. The jointless concrete slab of claim 21, wherein the secondary colloidal silica is an amorphous colloidal silica in an aqueous solution, and wherein silica particles of the secondary colloidal silica have a size ranging from about 10.0 nm to about 50.0 nm.

23. The jointless concrete slab of claim 19, wherein the concrete mixture comprises aggregate, cement, and water, and wherein the concrete mixture is defined by a water to cement ratio of between about 0.400 to about 0.450.

24. The jointless concrete slab of claim 19, wherein the at least one fiber selected from the group consisting of steel fibers and synthetic fibers represents between about 0.25% by volume to about 0.50% by volume of the poured concrete slurry.

25. The jointless concrete slab of claim 19, wherein the at least one fiber selected from the group consisting of steel fibers and synthetic fibers represents between about 0.20% by volume to about 0.50% by volume of the poured concrete slurry.

26. A jointless fiberless concrete slab set by pouring a concrete slurry onto a substrate, the poured concrete slurry comprising:
a) a concrete mixture; and
b) a colloidal silica admixture;
wherein, as the poured concrete slurry cures, the poured slurry hardens into a composite material taking the form of a jointless concrete slab, the jointless concrete slab defining capillary structures that at least in part fill with silica particles and lime, and wherein the silica particles and lime react to produce a gel structure of calcium silicate hydrate that at least partially fill the capillary structures;
whereby the calcium silicate hydrate reduces internal tensile forces acting on the jointless concrete slab.

27. The jointless fiberless concrete slab of claim 26, wherein the colloidal silica admixture is an amorphous colloidal silica in an aqueous solution, and wherein silica particles have a size ranging from between about 10.0 nm to about 100.0 nm.

28. The jointless fiberless concrete slab of claim 26, wherein the jointless concrete slab is set by pouring the concrete slurry onto the substrate and then applying a curing technique to the poured concrete slurry, and wherein the curing technique comprises spray-applying a secondary colloidal silica onto the poured concrete slurry.

29. The jointless fiberless concrete slab of claim 28, wherein the secondary colloidal silica also is spray-applied onto the poured concrete slurry subsequent to removing a trowel machine.

30. The jointless fiberless concrete slab of claim 28, wherein the secondary colloidal silica is an amorphous colloidal silica in an aqueous solution, and wherein silica particles of the secondary colloidal silica have a size ranging from about 10.0 nm to about 50.0 nm.

31. The jointless fiberless concrete slab of claim 28, wherein the secondary colloidal silica also is spray-applied onto the poured concrete slurry subsequent to cement in the poured concrete slurry being set.

32. The jointless fiberless concrete slab of claim 26, wherein the concrete mixture comprises aggregate, cement, and water, and wherein the concrete mixture is defined by a water to cement ratio of between about 0.400 to about 0.450.

33. The jointless fiberless concrete slab of claim 26, wherein the colloidal silica admixture represents between about 0.5% by weight of cement to about 10.0% by weight of cement in the concrete mixture.

34. A process for placing a jointless fiberless concrete slab on a substrate, the process comprising the steps of:
a) preparing a concrete slurry, the concrete slurry comprising:
i) a concrete mixture; and
ii) a colloidal silica admixture;
b) pouring the concrete slurry onto the substrate; and
c) allowing the concrete slurry to cure such that capillary structures develop as the jointless concrete slab sets from the poured concrete slurry, and such that the capillary structures of the slab at least in part fill with silica particles and lime, and such that the silica particles and lime react to produce a gel structure of calcium silicate hydrate that at least partially fill the capillary structures.

35. The process for placing a jointless fiberless concrete slab of claim 34, wherein the preparing step comprises preparing the concrete slurry with amorphous colloidal silica that is in an aqueous solution and that comprises silica particles having a size ranging from between about 10.0 nm to about 100.0 nm.

36. The process for placing a jointless fiberless concrete slab of claim 35, wherein the preparing step additionally comprises adding the colloidal silica admixture to the concrete slurry in ranges of between about 0.50% to about 10.0% by weight of cement in the concrete mixture.

37. The process for placing a jointless fiberless concrete slab of claim 34, additionally comprising the step of spray-applying a secondary colloidal silica onto the poured concrete slurry to facilitate curing thereof.

38. The process for placing a jointless fiberless concrete slab of claim 37, wherein the spray-applying step comprises spray-applying the secondary colloidal silica onto the poured concrete slurry subsequent to removal of a trowel machine and prior to cement in the poured concrete slurry being completely set.

39. The process for placing a jointless fiberless concrete slab of claim 37, wherein the spray-applying step comprises spray-applying the poured concrete slurry with an amorphous secondary colloidal silica in an aqueous solution having silica particles with size ranging from about 10.0 nm to about 50.0 nm.

40. The process for placing a jointless fiberless concrete slab of claim 37, wherein the spray-applying step comprises spray-applying the secondary colloidal silica onto the poured concrete slurry subsequent to cement in the poured concrete slurry being set.

41. The process for placing a jointless fiberless concrete slab of claim 34, wherein the process results in a jointless concrete slab wherein the colloidal silica admixture represents between about 0.5% by weight of cement to about 10.0% by weight of cement in the concrete mixture.

42. A jointless fiberless concrete slab set from a concrete slurry poured onto a substrate, the poured concrete slurry comprising a concrete mixture and a colloidal silica admixture, the jointless concrete slab comprising capillary structures that are at least in part filled with a reaction product of silica particles and lime, the reaction product being a gel structure of calcium silicate hydrate, whereby the calcium silicate hydrate reduces internal tensile forces acting on the jointless concrete slab.

43. The jointless fiberless concrete slab of claim 42, wherein the colloidal silica admixture is an amorphous colloidal silica in an aqueous solution, and wherein silica particles have a size ranging from between about 10.0 nm to about 100.0 nm.

44. The jointless fiberless concrete slab of claim 42, wherein the jointless concrete slab is set from the concrete slurry poured onto the substrate and cured by application of a spray-applied secondary colloidal silica, whereby the secondary colloidal silica facilitates curing of the poured concrete slurry.

45. The jointless fiberless concrete slab of claim 44, wherein the secondary colloidal silica is an amorphous colloidal silica in an aqueous solution, and wherein silica particles of the secondary colloidal silica have a size ranging from about 10.0 nm to about 50.0 nm.

46. The jointless fiberless concrete slab of claim 42, wherein the concrete mixture comprises aggregate, cement, and water, and wherein the concrete mixture is defined by a water to cement ratio of between about 0.400 to about 0.450.

47. The jointless fiberless concrete slab of claim 42, wherein the colloidal silica admixture represents between about 0.5% by weight of cement to about 10.0% by weight of cement in the set concrete slab.
